(19) United States
(12) Patent Application Publication
(10) Pub. No.: US 2007/0126983 A1
(43) Pub. Date: Jun. 7, 2007

(54) Method of manufacturing an optical article and the article thus obtained

(76) Inventors: Muriel Godeau, Charenton-le-Pont (FR); Noemie Lesartre, Charenton-le-Pont (FR)

Correspondence Address: FISH & RICHARDSON PC, P.O. BOX 1022, MINNEAPOLIS, MN, 55440-1022, US

(21) Appl. No.: 11/606,427

(22) Filed: Nov. 30, 2006

(30) Foreign Application Priority Data
Dec. 2, 2005 (FR) 05 12277

(51) Int. Cl. G02C 7/10

(52) U.S. Cl. 351/163

(57) ABSTRACT

The present invention relates to a method of manufacturing a polarized optical article, in particular a polarized ophthalmic lens, comprising at least the successive steps consisting respectively in: applying, to a constituent substrate of the optical article, a coating comprising at least one dye that is sensitive to photodegradation; and introducing, by imbibition, a UV absorber into said coating. The invention also relates to the optical article capable of being obtained according to this method.

### RELATED APPLICATIONS

Under 35 U.S.C. § 119, this application claims the benefit of a foreign priority application filed in France, serial number FR05 12277 filed Dec. 2, 2005.

### FIELD OF THE INVENTION

The invention relates to a method of manufacturing a polarized optical article, in particular a polarized ophthalmic lens, comprising a step of imbibing the article with a UV absorber under given conditions. It also relates to a polarized optical article, in particular obtainable according to said method.

It is known to introduce substances such as dyes or UV absorbers into optical lenses by a method known as impregnation or imbibition.

Thus, Application WO 02/059 054 discloses a method of impregnating a thin film, made up of a latex polymer matrix (especially of optionally crosslinked polyurethane) coated on an optical glass. The impregnation solution is applied by spin coating to the thin film and incorporates an additive such as a dye. Such a method makes it possible to obtain an ophthalmic lens comprising a tinted coating.

Application JP11-052101 discloses a method of impregnating the substrate of a lens with a solution incorporating a UV absorber and a dye for compensating the coloration of the lens induced by said UV absorber. The impregnation method is carried out at 90° C. for 15 minutes.

Finally, Application JP09-145901 discloses a method of impregnating a substrate of a plastic lens, using two successive solutions incorporating, in the first one, a UV absorber (for protecting the eye and the lens material against UV) combined with a dyeing aid and optionally with a dispersant, and, in the second one, a dye.

The inventions described in the aforementioned applications have enabled UV absorbers to be introduced into optical articles, and more particularly, into the constituent substrate of said article. Nevertheless, they are not always suitable for protecting dyes that are sensitive to photodegradation due to ultraviolet radiation. Among the dyes that are sensitive to such reactions mention may be made of the dichroic or photochromic dyes containing aromatic units, some of which may be sensitive to UV radiation. Such dichroic dyes may be used in combination with liquid crystals in order to introduce a polarization property into the article that comprises them, such as for example, polarized ophthalmic lenses.

There has been a great development in polarized lenses in recent years, in so far as they greatly improve visual comfort by limiting glare caused by reflections arising from reflective surfaces, such as water. This results in better contrast and depth perception.

In particular, it is known to use a bilayer coating with a polarizing function containing a liquid crystal polymer (LCP) layer incorporating dichroic dyes, and a “linear photopolymer (LPP)” layer in order to confer a polarizing function to the substrate comprising it. Such coatings are used for example in liquid crystal display screens, but may also be used with optical articles (U.S. Pat. No. 5,602,661, U.S. 2005/0151926, EP 1 593 990). Specifically, the LPP layer is made up of a material which, once polymerized under the effect of linearly polarized UV radiation, structures itself and leads to the organization of the liquid crystal molecules and the alignment of dichroic dyes along a particular direction.

The use of such a bilayer coating on an optical article, such as an ophthalmic lens, makes it possible to confer polarizing properties, particularly high-performance polarizing properties, to said lens. It is thus possible to obtain ophthalmic lenses having a relative transmission factor in the visible spectrum (Tᵥ) of between 80% and 6%, associated with a contrast ratio which is above that generally observed for polarizing lenses obtained by bonding or laminating a polarizing film, and which routinely achieves values above 100. The linear photopolymer (LPP) and liquid crystal polymer (LCP) coatings may be deposited by spin coating on an organic substrate. This method integrates fully in to production lines and especially allows production of ophthalmic lenses made from any type of substrate. This method is particularly well suited for the production of lenses comprising a substrate of high refractive index (n=1.6-1.67 or 1.74), since this method does not alter the centre thickness of the lens, a particularly sought-after optimization for high-index materials.

As previously indicated, the dichroic dyes present in these bilayer polarizing coatings are sensitive to UV rays, which generally leads to a loss of polarizing performance, in particular to a drop in the contrast ratio (CR), an increase in the transmission (Tᵥ %) and a colour change (ΔE), which is unacceptable for a polarizing lens that is to be used in strong sunlight conditions.

The incorporation of UV absorbers into the (LCP) solution (mixtures of liquid crystals, dichroic dyes and solvent(s)) before polymerization of the layer runs the risk of preventing the organization of the liquid crystals and, consequently, of leading to a poor alignment of the dichroic dyes, this leading to a weak polarizing performance. The effective protection of dichroic dyes would require proportions of UV absorbers for which the realization of this risk would become very likely.

This solution is therefore not compatible with the prerequisites.

It is therefore necessary to provide a method that makes it possible for UV absorbers to be introduced into a polarized optical article, which does not have the aforementioned drawbacks, and more particularly, which does not cause a change in the polarizing properties of the system and which does not generate adhesion problems with other coatings that the polarized article might contain.

The Applicant has now discovered that the imbibition of the optical article under given conditions enables this need to be met.

A subject of the present invention is therefore a method of manufacturing a polarized optical article, in particular a polarized ophthalmic lens, comprising at least the following successive steps consisting in:
applying, to a substrate of the optical article, a polymerized coating comprising at least one dye that is sensitive to photodegradation; and
introducing a UV absorber into said coating;
   characterized in that
(a) the polymerized coating comprising at least one dye that is sensitive to photodegradation is a bilayer coating comprising a first layer of linear photopolymers (LPP) and a second layer of liquid crystal polymers (LCP) comprising at least one dichroic dye; and
(b) the UV absorber is introduced into said coating by imbibition, said imbibition comprising the following steps:
   (b1) immersion of the article in an aqueous solution comprising the UV absorber and at least one dispersing agent, over a duration of between 10 seconds and 2 minutes, said solution being kept at a temperature between 80° C. and 99° C.; then
   (b1) rinsing of the article with a lower alcohol.

Another subject of the present invention is a polarized optical article obtainable according to the above method.

A further subject of the present invention is a polarized optical article, in particular a polarized ophthalmic lens, comprising:
a substrate;
a bilayer coating comprising a first layer of linear photopolymers (LPP) and a second layer of liquid crystal polymers (LCP) incorporating at least one dichroic dye; and
a UV absorber present, at least partially, in said bilayer coating.

In the present application, the definitions of certain terms must be understood in the following way:
“optical article” is understood to mean instrumentation and sight optical lenses, visors and ophthalmic lenses;
“ophthalmic lens” is understood to mean lenses fitting especially in a spectacle frame, for the purpose of protecting the eye and/or correcting the vision, these lenses being selected from afocal, unifocal, bifocal, trifocal and progressive lenses;
“substrate” is understood to mean the base constitutif transparent material of the optical lens, and more particularly of the ophthalmic lens. This material serves as support for the stack of one or more coatings, comprising especially polarizing coatings;
“coating” is understood to mean any layer, film or lacquer which may be in contact with the substrate, and/or with another coating deposited thereon, and which may be selected from tinted, anti-reflection, anti-soiling, impact-resistant, scratch-resistant, polarizing and anti-static coatings.

Furthermore, the term “lower alcohol” is understood to mean a monoalcohol incorporating 2 to 4 carbon atoms such as ethanol or isopropanol and in particular isopropanol. The substrate of the optical article, in particular of the ophthalmic lens, may be of mineral or organic type. As a non-limiting indication, mention may be made, as an organic substrate which may be used within the scope of the invention, of the substrates conventionally used in optics and ophthalmia. For example, substrates of the following types are suitable: polycarbonate; polyamide; polyimides; polysulphones; poly(ethylene terephthalate)/polycarbonate copolymers; polyolefins, especially polynorbornenes; diethylene glycol bis(allylcarbonate) polymers and copolymers; (meth)acrylic polymers and copolymers, especially (meth)acrylic polymers and copolymers derived from bisphenol A; thio(meth)acrylic polymers and copolymers; urethane and thiourethane polymers and copolymers; epoxy polymers and copolymers and episulphide polymers and copolymers. Advantageously, the invention is particularly well suited for ophthalmic lenses where the substrate is a poly(thio)urethane.

The first step of the method according to the invention comprises application of the bilayer coating. This coating comprises a layer of photopolymer(s) or photo-orientable polymer(s) deposited on the substrate and on which the layer of liquid crystal polymer(s) is deposited.

The application of this coating may be carried out according to a method comprising the following general successive steps consisting in:
1—preparing a solution of at least one linear photopolymer;
2—applying said solution to the substrate, in order to form a photoalignment layer;
3—applying UV radiation, in the presence of a polarizer, to said photoalignment layer, so as to structure it;
4—preparing a liquid crystal solution containing at least one dichroic dye;
5—applying said solution to said structured photoalignment layer;
6—crosslinking the liquid crystal layer using a UV light source.

The liquid crystal and/or linear photopolymer solutions may be applied by spin coating, dip coating or spraying. Application by spin coating is preferred in the present invention.

A bilayer coating of this type is especially described in Application EP-1 593 990.

The linear photopolymer layer may thus be made up of acrylic or methacrylic polymers, dendrimers or polyimides, having reactive groups of the following types: cinnamic acid derivatives, chalcones or coumarins. These materials may be transported in a solvent such as acetone or dichloromethane, or in a mixture of solvents such as methyl ethyl ketone/cyclopentanone. The photopolymerization step may be carried out after an optional step of solvent evaporation, and may be carried out by exposure to polarized UV light.

The liquid crystal polymers and dichroic dyes may be transported in a solvent such as cyclohexanone or in mixtures such as anisole/acetone, anisole/ethyl acetate, or anisole/cyclopentanone. The coating made up of a mixture of liquid crystals and dichroic dyes may be subjected (after an optional drying step) to UV radiation for polymerization.

The dichroic dyes may be polymerizable or non polymerizable dyes, preferably they are polymerizable. The preferred dichroic dyes have a high dichroic ratio, a high extinction coefficient and good solubility. They may be azo, perylene, anthraquinone or phenoxazine dyes. Azo and anthraquinone dyes are preferred as they are particularly compatible with the liquid crystal polymers used within the scope of the invention.

The applicant has demonstrated that this polarizing system, in spite of having a low glass transition temperature after cross-linking (Tg≈20° C.), could be imbibed with a solution of UV absorbers at a temperature above 80° C. without especially affecting the orientation of the dichroic dyes. This is easily demonstrated by measurements of the contrast ratio before and after the imbibing step. It is thus possible, with this system, to use high imbibing temperatures, around 95° C., which enable a rapid diffusion of the UV absorber into the polarizing system and therefore a UV cut-off close to 380 nm to be obtained after 30 seconds of imbibition. Furthermore, owing to its cross-linked structure, the aforesaid polarizing system prevents desorption of the UV absorber during subsequent treatment of the optical article, for example during application of a bilayer abrasion-resistant coating in the presence of sodium hydroxide and alcohol, and thus gives the article good chemical resistance.

The coating thus obtained has, generally, a thickness of 1 to 20 μm (micrometres), and preferably 3 to 8 μm.

The second step of the method according to the invention comprises the impregnation of at least one UV absorber into the polarized optical article.

Non-limiting examples of UV absorbers used in the method according to the invention are selected from benzotriazoles, in particular, hydroxyphenylbenzo-triazole; triazines such as hydroxyphenyl-S-triazine; hydroxybenzophenones; and oxalic anilides. The UV absorber is preferably selected from absorbers of the benzophenone and benzotriazole family. These absorbers are particularly suitable for absorbing UV rays at wavelengths generating the most important photodegradation of dyes that are sensitive to UV rays, in the range of interest within the scope of the invention.

The preferably used UV absorbers are CYASORB® UV-24, CYASORB® UV-1164L, CYASORB® UV-1164 A, CYASORB® UV-2337, CYASORB® UV-531, CYASORB® UV-5411 and CYASORB® UV-9, all commercially available from Cytec.

Other UV absorbers that can be used in the present invention are UVINUL® 300, UVINUL® 3008, UVINUL® 3040, UVINUL® 3048, UVINUL® 3049 and UVINUL® 3050, available from BASF.

Further examples of UV absorbers are TINUVIN® 1130, TINUVIN® 292, TINUVIN® 5151, TINUVIN® 99-2, TINUVIN® 384-2, TINUVIN® 3050, TINUVIN® 5055 and TINUVIN® 5060, available from Ciba.

Further examples of UV absorbers are SANDUVOR® 3041, SANDUVOR® 3051, SANDUVOR® 3063, SANDUVOR® 3070 and SANDUVOR® 3225, available from Clariant.

CYASORB® UV-24 is particularly preferred in the present invention; it is 2,2′-dihydroxy-4-methoxybenzophenone.

The aqueous impregnation solution contains a dispersing agent such as dodecylbenzenesulphonic acid. This dispersing agent avoids the formation of aggregates of the UV absorber within said impregnation solution.

The quantity of UV absorber within the impregnation solution must be large enough to allow a rapid impregnation of the polarizing coating present on the optical article, and small enough so as not to lead to aggregate formation within the impregnation solution. The rapid impregnation of the optical article is an important condition. In fact, if the immersion time of the optical article is too long (more than 2 minutes) a detachment of the coating from the surface of the constituent substrate of the optical article is observed.

The method of the invention makes it possible to introduce the UV absorber at least partially into the polarizing bilayer coating.

For this purpose, the immersion time of the optical article in the immersion bath is between 10 seconds and 2 minutes. This is the optimal time to obtain an optical article having an optimized photodegradation resistance, whilst at the same time retaining good cosmetic properties, a contrast ratio similar to that obtained for a polarized article that has not undergone the impregnation treatment, and also good properties of adhesion to the optical article both of said bilayer and of coatings which may be deposited on this bilayer. An immersion time of about 30 seconds is particularly preferred.

Furthermore, the temperature of the immersion bath, which ranges from 80° C. to 99° C., is preferably between 90° C. and 96° C., and more preferentially equal to 94° C. The immersion bath is an aqueous solution.

In addition to the aforesaid polarizing coating, the optical article manufactured according to the invention may comprise one or more coatings, such as for example: an abrasion-resistant coating, for example a bilayer coating, possibly applied to a primer layer; a tinted coating; a oxygen barrier coating; an anti-reflection coating, for example having four layers; a hydrophobic and oleophobic anti-soiling coating; or an antistatic coating. One or more of these coatings may be deposited directly onto the substrate before deposition of the bilayer polarizing coating or else onto said bilayer coating.

The primer layer, when it is used, improves the impact resistance of the article onto which it is deposited and also the bonding of the abrasion-resistant layer. The primer layer may be any primer layer conventionally used in the optics, and in particular ophthalmics, field. Typically these primers, in particular impact-resistant primers, are coatings based on (meth)acrylic polymers, polyurethane polyesters, or epoxy/(meth)acrylate copolymers.

The abrasion-resistant coating may be any abrasion-resistant coating conventionally used in the optics, and in particular ophthalmic optics, field. By definition, an abrasion-resistant coating is a coating that improves the resistance to abrasion of the final optical article compared with the same article without the abrasion-resistant coating.

The preferred abrasion-resistant coatings are those obtained by curing a composition incorporating one or more epoxyalkoxysilanes or a hydrolysate of these, silica and a curing catalyst. Examples of such compositions are disclosed in international application WO 94/10230 and US patents U.S. Pat. No. 4,211,823 and U.S. Pat. No. 5,015,523, and also in European Patent EP 614 957 and particularly in Example 3 of this patent. Thus an abrasion-resistant coating manufactured from compounds sold by Ultra Optics under the reference UV-NV may be used.

The oxygen barrier coating generally comprises either a dense metal oxide layer, or a metal oxide layer that is not dense, or a system comprising a stack of 1 to 4 different metal oxide layers.

This coating may be made up of a monolayer or multilayer film of materials such as SiO, SiO₂, Si₃N₄, TiO₂, ZrO₂, Al₂O₃, MgF₂ or Ta₂O₅, or mixtures thereof. Advantageously, the monolayer system comprises silicon dioxide, and has a thickness between 10 and 100 nm. The stack advantageously comprises an alternation of at least two different oxide monolayers, the latter being advantageously chosen from silicon, titanium and zirconium oxides. The stack of layers advantageously has a thickness between 50 nm and 300 nm, preferentially between 100 and 200 nm.

This oxygen barrier coating is applied by methods well known to those skilled in the art, and generally by vacuum deposition according to one of the following techniques:
by evaporation, optionally ion-beam assisted evaporation;
by ion-beam sputtering;
by cathode sputtering; and
by plasma-enhanced chemical vapour deposition.

The invention will now be illustrated by the following non-limiting example.

### EXAMPLE

### Preparation of a Polarized Ophthalmic Lens

1. Application of the Polarized Coating

A polarizing coating was applied to a high-index lens, the substrate of which was a polythiourethane. The preferred polythiol was 1,2-bis(2′-mercaptoethylthio)-3-mercaptopropane (MDO). The preferred isocyanate was m-xylenediisocyanate.

The procedure was as described in Patent Application EP 1 593 990.

A. Preparation of the LPP Layer and Deposition

The lens was washed in a 5% sodium hydroxide solution in an ultrasonic bath at 55° C. Next it was dipped in water then in deionized water (optionally in isopropanol). A 2 wt % solution comprising an acrylic polymer having cinnamic acid functional groups was prepared in a mixture (10:1) of methyl ethyl ketone and cyclopentanone. This solution was deposited by spin coating onto the lens substrate. The spin speed was 500 rpm for 3 seconds, then 2500 rpm for 20 seconds. The solvent was evaporated by heating in an oven at 100° C. for 20 minutes. This layer was irradiated under a UV polarizer at a dose of 100 mJ/cm².

B. Preparation of the LCP Layer and Deposition

A solution containing liquid crystal molecules and dichroic dyes that were sensitive to degradation by ultraviolet light was prepared in cyclohexanone. The solid portion contained in this solution was typically 40 wt %. The quantity of dichroic dye was about 10 wt %. This solution was deposited by spin coating onto the LPP layer (spin speed=500 rpm for 25 seconds). The LCP layer was dried for 10 minutes at a temperature of 87° C. After solvent evaporation, this layer was crosslinked under a nitrogen atmosphere by irradiation in the presence of a UV light source at a dose of 30 J/cm².

2. Imbibition of the Polarized Lens

A. Preparation of the Imbibing Bath

1500 ml of distilled water were heated to 94° C., with stirring, in a glass beaker placed on a magnetic stirrer. When the temperature reached 90° C., 3 g of dispersing agent (dodecylbenzenesulphonic acid) were added and dispersed in the water. Then 13.05 g of UV absorber CYASORB UV-24 were added to the solution containing the dispersing agent. The mixture was then stirred and heated for about 2 hours. The temperature of the bath was then 94° C.

B. Imbibition of the Lens

The lens was immersed for 30 seconds into the bath prepared as described above, before being rinsed in an isopropanol bath in order to eliminate the acid and UV absorber residues that were present on the lens surface.

C. Measurement of the UV Cutoff

The UV cut-off (wavelength at which the transmission becomes less than 1%) of the polarized coating alone was equal to 380 nm. This UV cut-off was measured using a spectrometer for a polarized coating deposited on a mineral biplanar surface.

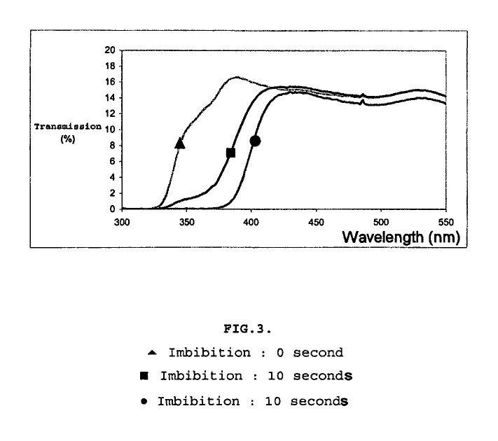

FIG. 3 shows the UV cut-offs recorded after zero, 10 second and 30 second imbibition times. The UV cut-off, initially at 330 nm, shifted to 345 nm after 10 seconds of imbibition, and then to 385 nm after 30 seconds.

3. Application of Abrasion-Resistant and Anti-Reflection Coatings

An abrasion-resistant bilayer coating was applied according to the following steps:
first, a latex primer layer was obtained according to the procedure disclosed in Example 1 of patent U.S. Pat. No. 5,316,791 using as the substrate an aqueous dispersion of polyurethane sold by Baxenden under the reference W-240. This first layer was deposited by dip coating onto the lens bearing the polarizing coating described in step 1 and the photodegradation-protective coating as described in step 2, and was heated to 87° C. for 4 minutes; the thickness of this layer was 1 μm;
a layer obtained according to the protocol disclosed in Example 3 of Patent EP 0 614 957 was then deposited onto this first layer. This second layer comprised, with respect to the total weight of the composition, 22% glycidoxypropylmethyldimethoxysilane, 62% colloidal silica, representing 30% of the solid portion in methanol, and 0.70% aluminium acetyl acetonate (a catalyst), the difference to 100 wt % mainly being water. This layer was deposited by dip coating the lens in said solution and was then polymerized for 3 hours at 100° C. The thickness of the resulting layer was 3.5 μm.

A traditional four-layer anti-reflection coating comprising alternate zirconium oxide and silicon oxide layers was then applied until a total stack thickness of 200 nm was achieved.

The various layers were produced in a BAK machine, by rotating under a high vacuum of 2×10⁻⁵ torr.

4. Suntest UV Aging Test

The following configurations were compared by accelerated aging tests carried out using a Suntest:

Example 1: lens comprising a bilayer polarized coating, an abrasion-resistant bilayer coating and a four-layer anti-reflection coating.

Example 2: lens comprising an imbibed bilayer polarized coating, an abrasion-resistant bilayer coating and a four-layer anti-reflection coating.

The principle of this test is described below:

Glasses were placed in the Suntest equipment which produced an illumination of 60 klux. They underwent successive solar aging cycles of 50 hours. The total exposure duration varied from 50 to 200 hours. At the end of each illumination cycle, one or more optical characteristics of the product were measured to determine a possible change. They were mainly the transmission in the visible spectrum (Tᵥ), the contrast ratio (CR) and determination of the colour parameters (L*, a*, b*).

For each of the configurations, the transmission (Tᵥ), the contrast ratio (CR) and the colour change (ΔE=\sqrt{(ΔL²+Δa²+Δb²)}) were measured.

The results are given in Tables 1 and 2 below:

TABLE 1
Non-imbibed polarized lens

| Suntest | | | | |
|---|---|---|---|---|
| time | Tᵥ (%) | ΔTᵥ/Tᵥ | ΔE | CR |
| 0 h | 16.01 | 0 | 0 | 298 |
| 25 h | 16.91 | 5.6 | 2.0 | — |
| 50 h | 17.81 | 11.2 | 3.7 | 188 |
| 75 h | 17.78 | 11.0 | 4.0 | 127 |
| 100 h | 19.50 | 21.8 | 6.2 | 121 |
| 200 h | 21.09 | 31.7 | 8.7 | 75 |

TABLE 2
Imbibed polarized lens

| Suntest | | | | |
|---|---|---|---|---|
| time | Tᵥ (%) | ΔTᵥ/Tᵥ | ΔE | CR |
| 0 h | 17.47 | 0 | 0 | 210 |
| 25 h | 17.99 | 2.9 | 1.0 | — |
| 50 h | 17.95 | 2.7 | 1.1 | 156 |
| 75 h | 18.22 | 4.2 | 1.4 | 123 |
| 100 h | 18.96 | 8.4 | 2.3 | 123 |
| 200 h | 18.90 | 8.2 | 3.7 | 84 |

As is shown in these tables, imbibing the lens leads to a lower decrease in the effectiveness of the polarization, measured by the contrast ratio CR after a 50 h Suntest. Above all, the colour change ΔE of the lenses is lower and the transmission Tᵥ increase is noticeably smaller.

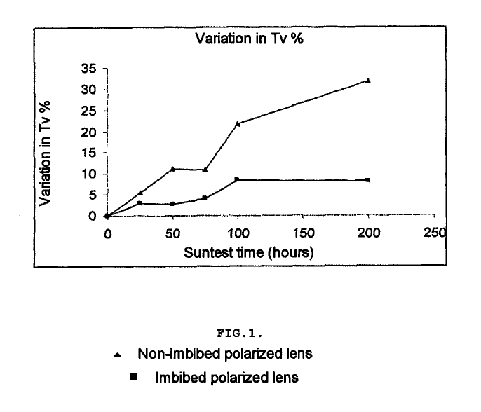

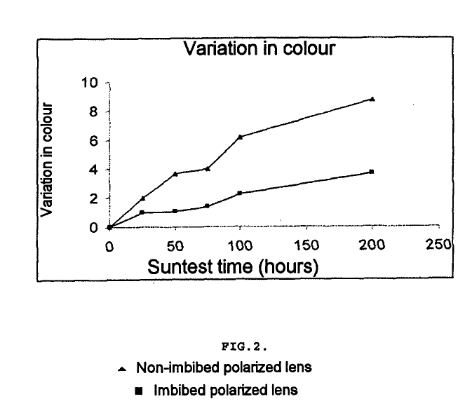

FIGS. 1 and 2 show the variations in Tᵥ values and in the colour (ΔE).

1. A method of manufacturing a polarized optical article, in particular a polarized ophthalmic lens, comprising at least the following successive steps of:
applying, to a substrate of the optical article, a polymerized coating comprising at least one dye that is sensitive to photodegradation; and
introducing a UV absorber into said coating;
wherein
(a) the polymerized coating comprising at least one dye that is sensitive to photodegradation is a bilayer coating comprising a first layer of linear photopolymers (LPP) and a second layer of liquid crystal polymers (LCP) comprising at least one dichroic dye; and
(b) the UV absorber is introduced into said coating by imbibition, said imbibition comprising the following steps:
(b1) immersion of the article in an aqueous solution comprising the UV absorber and at least one dispersing agent, over a duration of between 10 seconds and 2 minutes, said solution being kept at a temperature of between 80° C. and 99° C.; then
(b2) rinsing of the article with a lower alcohol.

2. The method according to claim 1, wherein said substrate is selected from the group consisting of polycarbonate; polyamide; polyimides; polysulphones; poly(ethylene terephthalate)/polycarbonate copolymers; polyolefins, especially polynorbornenes; diethylene glycol bis(allylcarbonate) polymers and copolymers; (meth)acrylic polymers and copolymers; thio(meth)acrylic polymers and copolymers; urethane and thiourethane polymers and copolymers; epoxy polymers and copolymers and episulphide polymers and copolymers.

3. The method according to claim 2, wherein the substrate is a poly(thio)urethane.

4. The method according to claim 1, wherein the application of the bilayer coating is carried out according to a method comprising the following successive steps:
1—preparing a solution of at least one linear photopolymer;
2—applying said solution to the substrate, in order to form a photoalignment layer;
3—applying UV radiation, in the presence of a polarizer, to said photoalignment layer, so as to structure it;
4—preparing a liquid crystal solution containing at least one dichroic dye;
5—applying said solution to said structured photoalignment layer;
6—crosslinking the liquid crystal layer using a UV light source.

5. The method according to claim 1, wherein said UV absorber is selected from the group consisting of benzotriazoles, triazines, hydroxybenzophenones, and oxalic anilides.

6. The method according to claim 5, wherein said UV absorber is 2,2′-dihydroxy-4-methoxybenzophenone.

7. The method according to claim 1, wherein the dispersing agent is dodecylbenzenesulphonic acid.

8. The method according to claim 1, wherein the immersion time of the optical article in the solution containing the UV absorber is about 30 seconds.

9. The method according to claim 1, wherein the temperature of the immersion bath is between 90° C. and 96° C.

10. The method according to claim 9, wherein the temperature of the immersion bath is equal to 94° C.

11. The method according to claim 1, wherein the optical article further comprises one or more coatings selected from the group consisting of an abrasion-resistant coating, optionally applied to a primer layer; a tinted coating, an oxygen barrier coating, an anti-reflection coating, a hydrophobic and oleophobic anti-soiling coating, and an anti-static coating.

12. An optical article obtainable according to the method defined in any one of claims 1 to 11.

13. A polarized optical article comprising:
a substrate;
a bilayer coating comprising a first layer of linear photopolymers (LPP) and a second layer of liquid crystal polymers (LCP) incorporating at least one dichroic dye; and
a UV absorber present, at least partially, in said bilayer coating.

14. The polarized optical article according to claim 13, said polarized optical article being a polarized ophthalmic lens.
